(19) United States
(12) Patent Application Publication
(10) Pub. No.: US 2006/0145946 A1
(43) Pub. Date: Jul. 6, 2006

(54) Transflective display device having a black/white or half-tone display in the reflecting operating mode

(76) Inventors: Markus Baur, Nersingen-Leibl (DE); Armin Toth, Dornstadt-Tomerdingen (DE)

Correspondence Address: BELL, BOYD & LLOYD, LLC, P. O. BOX 1135, CHICAGO, IL, 60690-1135, US

(21) Appl. No.: 10/545,267

(22) PCT Filed: Jan. 23, 2004
(86) PCT No.: PCT/EP04/00579

§ 371 Date: Aug. 10, 2005

(30) Foreign Application Priority Data
Feb. 14, 2003 (DE) 103 06 291.2

(51) Int. Cl. G09G 5/00

(52) U.S. Cl. 345/8

(57) ABSTRACT

A transflective display device comprising a first transparent substrate for letting in light of a background lighting, whereby the first transparent substrate is provided with first electrodes. The display device also comprises a second transparent substrate for displaying graphic patterns, whereby the second transparent substrate is provided with second electrodes. An electro-optical material is provided, in particular, in the form of a liquid crystal layer between the first and the second transparent substrate. The display device additionally comprises pixel sections that are provided in overlapping areas of the respective first and second electrodes, have a respective reflecting element for reflecting light let in through the second substrate, and have a color filter element for filtering and permitting light, which is let in through the first substrate, to pass through in the direction of the second substrate. The reflecting element is placed on sides of the second substrate, and the color filter element is placed on sides of the first substrate. This enables, during the transmissive operating mode of the display device, a colored display of graphic patterns whereas during the reflective operating mode, a black/white display or half-tone display of a high contrast and high brightness is provided.

### FIELD OF TECHNOLOGY

The present disclosure relates to a transflective display device which provides a color display in a transmissive operating mode in particular, while providing a black/white display or half-tone display in a reflective operating mode.

### BACKGROUND

An important component of a liquid crystal display (LCD) is a layer of liquid crystals between two alignment layers. Molecules of liquid crystal have an elongated-oval form and align themselves in parallel without external influence. It is also a property of liquid crystals that they align themselves to surfaces having a grooved structure in the direction of the structure. As shown in FIG. 1, as a result of their molecular structure, liquid crystals LC in the nematic phase align themselves to surfaces OF1, OF2 having a grooved structure and acting as alignment layers here, and as a result of their mechanical properties, twist themselves in a spiral manner when they are introduced between two alignment layers that are twisted by 90° (shown here by the arrows a and b of the surfaces OF1 and OF2). This arrangement is designated Twisted Nematic (TN) if the angle of twist is 90°, and Super Twisted Nematic (STN) if the angle of twist is 270°. If an electrical field is applied between the two layers, the liquid crystal molecules align themselves along the direction of the field.

In addition to the structure shown in FIG. 1, a liquid crystal display also requires two polarizers and at least two electrodes, an image dot section being produced in the overlap area of said electrodes. If a light (e.g. from a background illumination) which has been polarized by the first or rear polarizer P1 now hits the spirally arranged liquid crystals LC, as shown in FIG. 2A, this light is rotated in its polarization direction in accordance with the angle of twist of the molecules. It then hits the second or front polarizer P2 (analyzer), whose polarization direction is twisted by 90° in relation to that of the first polarizer P1. The light can therefore penetrate through to an observer (in a downward direction in the figure).

If, as shown in FIG. 2B, an electrical field is generated by a voltage source VOL and applied to the liquid crystal molecules LC via the alignment layers ARL (corresponding to the surfaces OF1 and OF2 from FIG. 1), the liquid crystal molecules LC align themselves to the electrical field accordingly. Light which now comes in from above onto the liquid crystal arrangement that is illustrated in FIG. 2B is first polarized by the polarizer P1, then penetrates through the upper alignment layer ARL and then follows the orientation of the liquid crystals again. In the present case, since the polarization plane of the light is not rotated by 90° as it was in FIG. 2A, the light cannot penetrate downwards, i.e. through the second polarizer P2. Therefore, by means of electrically controlling the arrangement of the liquid crystals, it is possible to influence their optical properties (particularly in relation to transmissivity).

What has just been explained in relation to the FIGS. 2A and 2B is the control of a single image dot section. A conventional liquid crystal display device includes a multiplicity of such image dot sections, however, wherein graphical patterns such as alphanumeric characters, symbols, graphics, photos, etc. can be displayed on the liquid crystal display device by means of selectively controlling said image dot sections. For this purpose, the liquid crystal display device includes a first transparent substrate, e.g. made of glass, upon which a first polarizer is deposited. It also has a second transparent substrate upon which a second polarizer is deposited, whose polarization plane is twisted by 90° in relation to that of the first polarizer. There is a layer of liquid crystals between the two substrates. Furthermore, provision is made for a matrix-type arrangement of electrodes, e.g. row electrodes on the first substrate and column electrodes on the second substrate. In the overlap area of such a row electrode and column electrode, it is then possible to define an image dot section which can be specifically and electrically controlled. In relation to the control of the individual image dot sections, a distinction is made between an active matrix liquid crystal display (AMLCD) and a passive matrix liquid crystal display (PMLCD). Since the individual image dot sections are controlled directly by a matrix-type arrangement of row electrodes and column electrodes in the case of a PMLCD, it follows that in principle each individual cell is only controlled for 1/(resolution=total number of image dot sections) of the total time of the image display. Because the cells are in a voltage-free state for the remainder of the time, the liquid crystals must be configured in such a way that they are correspondingly slow-acting, in order to ensure that they do not revert during the remaining time and thereby to prevent any loss of contrast or flimmer effects.

In the case of an AMLCD, however, each image dot section is controlled by a dedicated thin-film transistor (TFT) which stores the information for the relevant image dot section.

Since white light is normally used for the background illumination of a liquid crystal display device, said light must be filtered using suitable color filters in order to display color images. A specific color filter is assigned to each individual image dot section in this case, there being customarily three types of color filter, namely a red filter, a yellow filter and a blue filter. Three image dot sections with these three different color filters are then combined to form a pixel.

In addition to the previously described transmissive operating mode of a liquid crystal display device, in which light of a background illumination comes through a first polarizer or a first substrate into the display device and, after being influenced if necessary by means of the liquid crystal layer in an image dot section, is allowed out again through the second substrate or the second polarizer for the purpose of displaying graphical patterns, there is also a reflective operating mode in the case of a transflective display device. In this context, light of a background illumination is not allowed in through the first polarizer (the first substrate), but instead ambient light comes through the second polarizer (the second substrate) into the display device, passes through the liquid crystal layer and is ultimately reflected by a transflective layer which is advantageously deposited on the first substrate. In this case, this transflective layer has reflection elements for reflecting light and also has transit openings or slots for allowing the passage of light (which comes from a background illumination and must be allowed through in the direction of the second substrate).

A liquid crystal display device having a conventional arrangement of the individual components is described schematically below with reference to FIGS. 3 and 4, in which relevant cross-sectional views of a liquid crystal display device are shown.

FIG. 3 shows a liquid crystal display device A1 in which three image dot sections BPA1, BPA2 and BPA3 (characterized by vertical broken lines) are represented with different color filters in each case FF1 (having the color red), FF2 (having the color yellow) and FF3 (having the color blue) for the purpose of illustration. In this case, the relevant image dot sections are produced in the overlap area of a first electrode E1 and three electrodes E21, E22 and E23 which run perpendicular to said first electrode. In this case, the electrodes are manufactured from a transparent material, e.g. indium tin oxide (ITO). The electrode E1 is arranged on a first transparent substrate S1, and a first polarizer P1 is deposited on the opposite side of said first substrate. The electrodes E21, E22 and E23 are deposited on a second transparent substrate S2, and a second polarizer P2 is deposited on the opposite side of said second substrate. Furthermore, reflection elements R1, R2 and R3 are advantageously configured as part of a transflective layer on the first electrode, wherein a relevant color filter FF1, FF2 and FF3 is provided on a relevant reflection element. In this case, a part of a relevant color filter FF1, FF2 and FF3 overlaps a relevant reflection element, while a further part extends beyond the relevant reflection element. A layer of liquid crystals is then provided between the color filters FF1 to FF3 and the relevant second electrode E21 to E23 (this being omitted for reasons of clarity in the drawing).

In a transmissive operating mode of the liquid crystal display A1 as shown in FIG. 3, in which light (characterized by three arrows running diagonally upwards) is provided by a light source for background illumination, this light penetrates through the first polarizer P1 and the first transparent substrate S1 into the liquid crystal display, where it hits not only the reflection elements R1 to R3, at which it is reflected back again, but also those parts of the relevant color filters that extend beyond the reflection elements. The normally white background light (characterized by the letter “W” at the foot of each respective arrow) is filtered by these extending parts of the color filters, and can then be allowed out again through the second transparent substrate S2 and the second polarizer P2 (towards the top in the figure) as a result of corresponding control of a relevant image dot section (by means of the electrodes E1, E21, E22, E23).

FIG. 4 shows the same liquid crystal display device A1 as FIG. 3, wherein a reflective operating mode of the display device will now be explained. It is evident from the figure that light from a background illumination does not come in through the first polarizer P1 and the first substrate S1 in this case, but that ambient light (normally white ambient light, characterized by the letter “W”) enters through the second polarizer P2 and the second substrate S2 into the display device, passes through the relevant second electrodes and the liquid crystal layer and ultimately arrives at a relevant color filter FF1 to FF3. The light now passes through a relevant color filter a first time on the way (in a downwards direction in the figure) to a relevant reflection element R1 to R3, is reflected at a reflection element and then passes through the color filter a second time, so that finally a filtered light is allowed out of the display device or the second polarizer P2, said light corresponding to the color of the color filter it has just passed through.

A conventional display device of this type as per FIGS. 3 and 4 has the disadvantage that, particularly in reflective mode, the display which is presented by the display device at the outer surface of the polarizer P2 appears very dark and is therefore difficult to read as a result of the fact that incoming ambient light must pass through a color filter twice.

The present disclosure therefore addresses the problem of creating a display device which is easily readable in both transmissive mode and reflective mode.

### BRIEF SUMMARY

A display device is disclosed herein, having a first transparent substrate for letting in light of a background illumination, wherein the first transparent substrate is equipped with first electrodes. The display device also has a second transparent substrate for allowing light through or out, with the light having been modified or influenced in the display device, wherein the second transparent substrate is equipped with second electrodes. An electro-optical material is provided between the first and the second transparent substrate. The display device also has image dot sections which are provided at the overlapping areas of the relevant first and second electrodes and have in each case a reflection element for reflecting light which comes in through the second substrate and a color filter element for filtering the light coming in through the first substrate and allowing it to pass through in the direction of the second substrate. In this case, a color filter element can have a section or part which overlaps the reflection element and a part which extends beyond the reflection element, wherein this extending part can allow light to pass through the color filter element from the first substrate in the direction of the second substrate. In this case, the reflection element is arranged on the side of the second substrate and the color filter element on the side of the first substrate.

Such an arrangement has the effect that, in the transmissive mode of the display device, light can now enter into the display device through the first transparent substrate, arrives at a relevant color filter of an image dot section, is either blocked or allowed to pass through in the direction of the second substrate in accordance with a control of the image dot section by means of the electrodes, in order to provide on the outer side or outer surface of said second substrate a color display including color graphical patterns for a user.

In the reflective operating mode, however, in which light is allowed into the display device through the second transparent substrate, the light after passing through the electro-optical material now arrives directly at the relevant reflection elements of the image dot sections and is reflected by them. Once again, the light is then either blocked or allowed to pass out through the second substrate again in accordance with the control of the image dot section by means of the electrodes, in order to provide on the outer side of said second substrate a display (of graphical patterns) for a user. As a result of the fact that light no longer passes through a color filter in the reflective mode, which it does in the prior art, the display device disclosed herein only provides a grayscale display (of graphical patterns) in the reflective mode under an exemplary embodiment. However, the contrast and the brightness of the display is significantly improved using this type of configuration, thereby improving the readability of the display, whether it comprises characters, symbols, graphics or photographs.

Accordingly, the display device can furthermore include a first polarizer which is assigned to the first transparent substrate and is deposited thereupon, and a second polarizer which is assigned to the second transparent substrate and is deposited thereupon and has a polarization plane that is perpendicular to that of the first polarizer. In this case, the polarizers can be deposited on the relevant inner surface (i.e. on the side of the electro-optical material) or outer surface of the relevant substrates.

Furthermore, the electro-optical material can comprise a layer of liquid crystals.

In accordance with a further advantageous development, the first electrodes are arranged parallel to each other and extend in a first direction, while the second electrodes are likewise arranged parallel to each other and extend in a second direction which is perpendicular to the first direction. In this way, a matrix-type electrode arrangement with column electrodes and row electrodes can be implemented, wherein the image dot sections in the overlapping areas can be electrically controlled. In this case, the first and second electrodes advantageously consist of a transparent material, e.g. indium tin oxide (ITO).

Furthermore, the display device is preferably developed as an active matrix liquid crystal display, such as a TFT (Thin Film Transistor) liquid crystal display, or as a passive matrix liquid crystal display, as well as a CSTN (Color Super Twisted Nematic) liquid crystal display.

The display device may alternately have its own light source which is arranged adjacently to the first transparent substrate or the first polarizer on the opposite side to the electro-optical material. This means that the light source is arranged outside of the actual image generating entity and is used to provide light that is required for creating a display of graphical patterns in the transmissive mode of the display device.

The color filter elements advantageously comprise the colors red, yellow and blue, wherein one color pixel is represented in each case by three adjacent image dot sections having the colors red, yellow and blue.

In accordance with a further embodiment of the disclosure, an electrical apparatus is disclosed that comprises a display device as described above or advantageous developments thereof. In this way, it is possible that the electrical apparatus has an apparatus-internal light source for providing a background illumination for the display device, wherein the apparatus-internal light source is arranged on the side of the first transparent substrate. In this case, a display device-internal light source can be omitted. The electrical apparatus is preferably developed as a mobile apparatus, in particular as a mobile telephone or mobile radio apparatus, as a portable computer such as a PDA (personal digital assistant) or a clock, etc.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a schematic illustration of liquid crystal molecules which are arranged between two alignment layers;

FIGS. 2A and 2B illustrate a schematic of the main components of a liquid crystal display, in order to explain the control of the light passage depending on an electrical field which acts on a liquid crystal layer;

FIG. 3 is a schematic cross section view of a conventional transflective liquid crystal display which is currently being used in the transmissive operating mode;

FIG. 4 is a schematic illustration of the same display device as in FIG. 3, wherein a reflective operating mode is shown in this case;

FIG. 5 is a schematic cross sectional view of a liquid crystal display according to one embodiment, wherein a transmissive operating mode is illustrated;

FIG. 6 is an illustration of the liquid crystal display as in FIG. 5, wherein a reflective operating mode is shown;

FIG. 7 is a schematic illustration of an electrical apparatus which is implemented in the embodiment of a mobile radio apparatus or mobile telephone; and

FIG. 8 is a schematic illustration of an electrical apparatus which is implemented in the embodiment of a small portable computer.

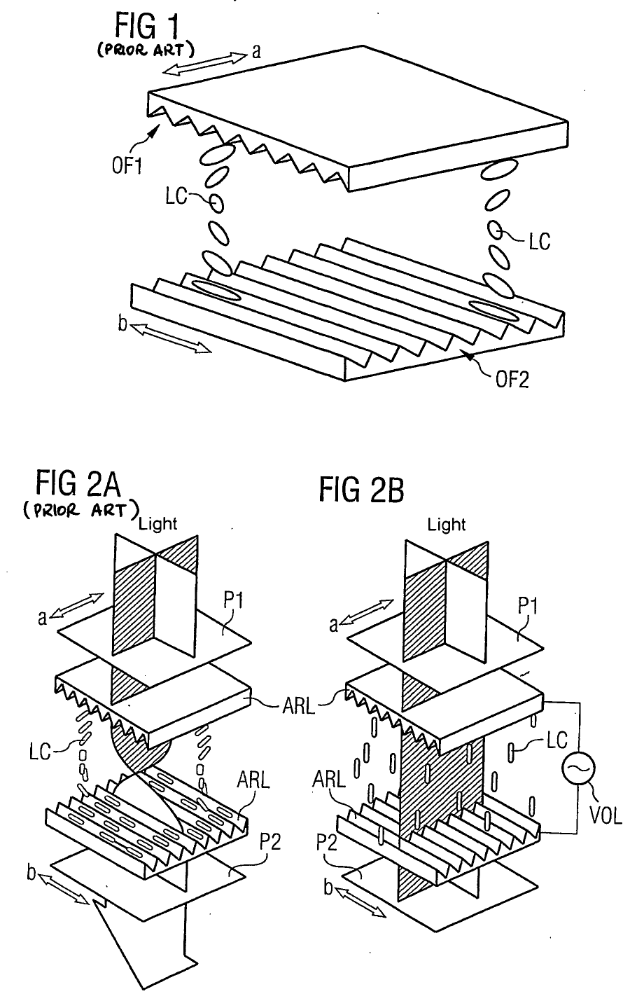

### DETAILED DESCRIPTION

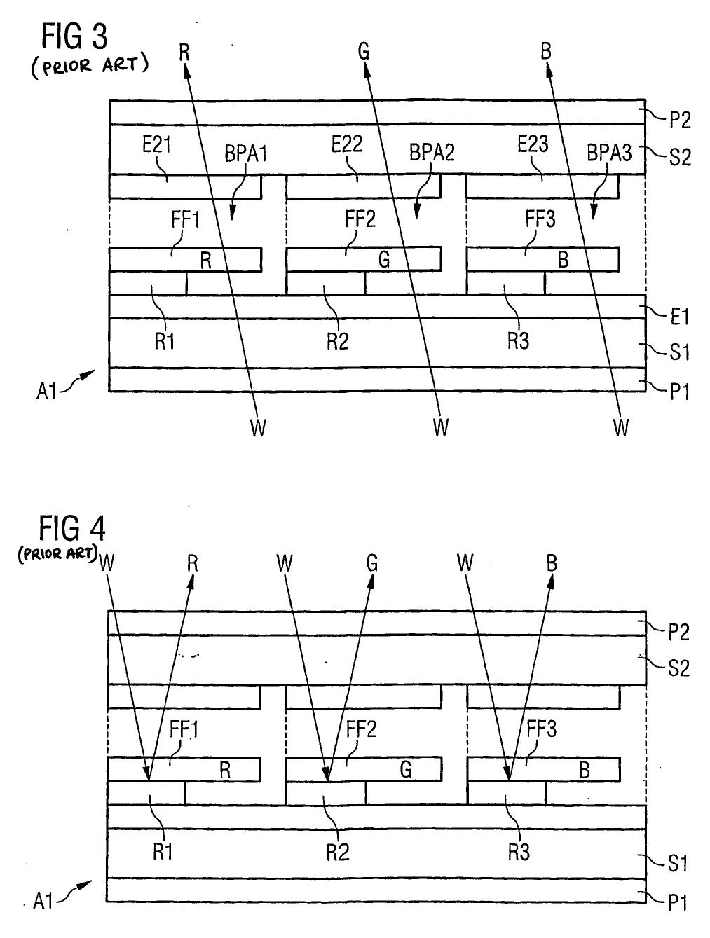

One exemplary embodiment of the present invention is described with reference to FIG. 5. In this case, FIG. 5 shows a schematic cross sectional view of the main components of a transflective liquid crystal display device A2. Similar to the liquid crystal display device A1 in FIG. 3, the liquid crystal display device A2 comprises a first transparent substrate S1 and a second transparent substrate S2, between which is arranged an electro-optical material in the form of a liquid crystal layer LC as shown in FIG. 5. Glass substrates are advantageously used as the transparent first and second substrates. A polarizer P1 is also deposited on the outer surface of the first transparent substrate S1, while a first electrode E1 is deposited on the inner side. A polarizer P2 is deposited on the outer surface of the second transparent substrate S2, while relevant electrodes E21, E22 and E23 are deposited on the inner surface. It should be noted here that the display device A2 has further electrodes in addition to the electrodes that are visible in the figure, i.e. further first electrodes that are arranged parallel to electrode E1 on the first substrate S1 and further second electrodes are arranged parallel to the electrodes E21, E22 and E23 on the second substrate S2. In this case, the first and second electrodes form a matrix-type structure with row electrodes and column electrodes.

Relevant image dot sections BPA1, BPA2 and BPA3 are implemented in the overlap areas of the first electrode E1 and the second electrodes E21 to E23, where the image dot sections is characterized by broken vertical lines. It should be noted that the image dot sections are not restricted to the space between the electrodes, but relate to an area of the display device, which area is individually controllable and has a relevant reflection element or color filter element. In this case, the image dot section BPA1 includes a first reflection element R1 and a first color filter element FF1 representing the color “red”, the second image dot section BPA2 includes a second reflection element R2 and a second color filter element FF2 representing the color “yellow”, while the third image dot section BPA3 includes a third reflection element R3 and a third color filter element FF3 representing the color “blue”. In this case, the relevant reflection elements have an almost 100% reflection property and are developed from aluminum, for example. In this case, it is possible that the reflection elements are developed as part of a transflective layer which is deposited over the color filter elements. This transflective layer includes the reflection elements in this case and, between the reflection elements, has transit openings or slots through which the light can pass. As illustrated in the figure, the color filter elements are arranged in such a way that they have an area which overlaps the relevant reflection element and a part which extends beyond the reflection elements. It is characteristic of the illustrated embodiment that the reflection elements are arranged on the side of the second substrate, while the color filter elements are arranged on the side of the first substrate, i.e. on the entry side of light from a background illumination (from below in the figure). As shown in the figure, it is conceivable to deposit the relevant color filter elements on the first electrode (or electrodes), while the reflection elements (or the transflective layer) are deposited on the color filter elements.

If the liquid crystal display device A2 is now operated in the transmissive operating mode as shown in FIG. 5, light (characterized by three arrows running diagonally upwards and leftwards) from a light source LQ for background illumination is allowed into the display device from below in the figure through the first polarizer P1, penetrates the transparent substrate S1 and the first electrode E1 and arrives at a relevant color filter element FF1 to FF3. The light source LQ, which is arranged below the actual imaging part of the liquid crystal display device A2 in the figure, i.e. on the side of the first transparent substrate S1 or the first polarizer P1, can have e.g., one or more LEDs (LED: light-emitting diode) or an optical conductor which receives light from an LED or a tubular lamp and supplies it to the imaging part as shown in the figure. The normally white light of the light source or background illumination (characterized by the letter W) at the origin of an arrow representing a background light is appropriately filtered in a relevant color filter element FF1 to FF3 and then passes through the layer LC of liquid crystals, the relevant second electrodes E21 to E23 and the second transparent substrate, and emerges from the display device through the second polarizer P2 in the color of the color filter through which it passed. This presupposes that the image dots BPA1 to BPA3 are controlled via the electrodes E1 or E21 to E23 in such a way that light can pass through.

This means that in this case of the transmissive operating mode, in which a light source for background illumination is provided on the side of the first substrate S1 or the first polarizer P1, a color display and color graphical patterns are provided on the side of the second substrate or its assigned second polarizer. The three image dot sections BPA1, BPA2, BPA3 which are illustrated by way of example in the figure represent a (color) pixel in this case.

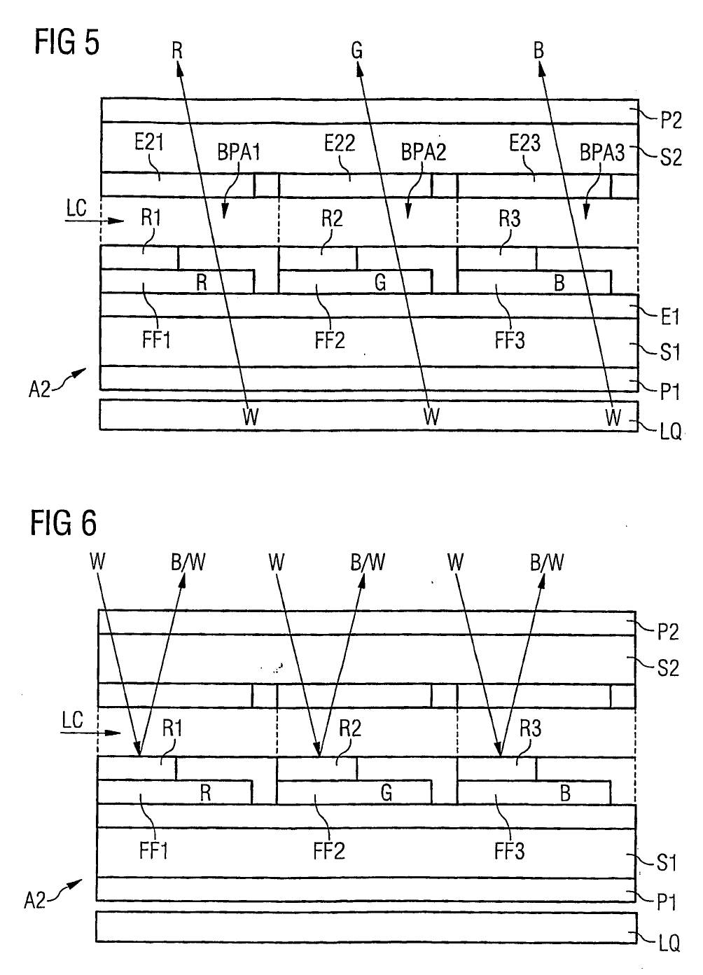

With reference to FIG. 6, there now follows an explanation of a reflective operating mode of the display device which was previously described in FIG. 5. In order to improve the illustration, FIG. 6 only includes those reference signs that are required for understanding. In contrast to the transmissive mode as shown in FIG. 5, no light of a background illumination penetrates from the side of the first polarizer P1 or the first substrate S1 into the display device A2 in the reflective mode, i.e. in contrast to the transmissive mode, the light source LQ is switched off in the reflective mode. Instead, an ambient light (normally white ambient light) which is characterized by the letter W now penetrates from above through the second polarizer P2 into the display device A2, passes through the second transparent substrate and the relevant second electrode and the layer LC of liquid crystals, and finally arrives at projecting or extending parts of the color filter elements, which it simply passes through, and at the relevant reflection elements R1, R2 and R3. The light is directly reflected at these reflection elements, without having to pass through a relevant color filter element twice as it must in the prior art (cf. FIG. 4). Depending on the control of an image dot section via the first and second electrodes, the white light which entered the liquid crystal display device A2 is allowed out again as white light, or no light is allowed out in an image dot section when a corresponding electrical field is applied to the liquid crystal layer LC (characterized by the letters B/W for black (no light) or white (light) at the end of the exit part).

This means that, instead of a color display with color graphical patterns, a black/white display or grayscale display is provided on the outer surface of the second polarizer P2 which is assigned to the second substrate (i.e. on the display surface) in the reflective operating mode of the display device A2. As mentioned above, since the incoming ambient light in the reflective mode of the display device does not have to pass through a color filter element twice as it must in the prior art (once before the reflection at a reflection element and once after the reflection at the reflection element), the intensity of the light is attenuated less and the display device A2 provides a black/white display or grayscale display with greater brightness and higher contrast, thereby improving the readability of graphical patterns such as symbols, characters, graphics or images. This means that, by switching off the background illumination (e.g. manually by a user or automatically by a control device if a charge of the battery supplying the display device or background illumination falls below a specified level), it is possible to select a current-saving (reflective) mode which nonetheless allows a good readability of the display. It is therefore possible to extend the service duration of an electrical apparatus comprising the display device A2.

It can therefore be stated in summary that, by means of the special configuration of the image dot sections, in which a relevant reflection element is arranged on the side of the second substrate and the corresponding color filter element on the side of the first substrate or on the side of the light source LQ, a color display is provided in the transmissive mode (with the light source switched on), while a black/white display or a grayscale display with high brightness and high contrast is provided in the reflective mode (with the light source switched off).

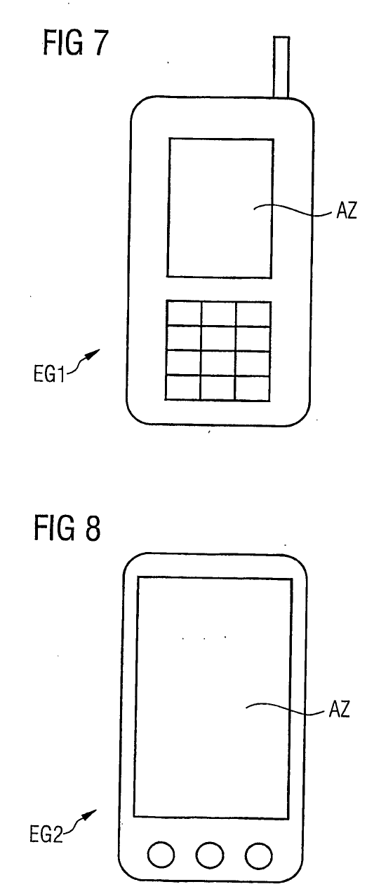

A display device in accordance with the present disclosure can be used in an electrical apparatus as illustrated schematically in the embodiments shown in FIGS. 7 and 8.

A display device AZ according to the embodiments (e.g. the display device A2) can be provided in an electrical apparatus EG1 which is developed in the form of a mobile radio apparatus or mobile telephone as shown in FIG. 7.

However, a display device AZ according to the present invention (e.g. the display device A2 again) can also be installed in an electrical apparatus EG2 in the form of a portable computer (particularly in the embodiment of a PDA) as shown in FIG. 8.

It should be understood that various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

1-11. (canceled)

12. A display device comprising:
a first transparent substrate having first electrodes;
a second transparent substrate having second electrodes;
an electro-optical material, provided between the first and the second transparent substrate;
a background illumination which is arranged adjacently to the first transparent substrate on the opposite side to the electro-optical material and is designed to emit light in the direction of the first transparent substrate;
image dot sections, provided at overlapping areas of the relevant first and second electrodes, wherein each image dot section includes a reflection element for reflecting light which comes in through the second transparent substrate, and a color filter element for filtering the light coming in through the first transparent substrate and allowing it to pass through in the direction of the second substrate; and
a display surface arranged on the opposite side of the second transparent substrate to the electro-optical material,
wherein the reflection element is oriented towards the second substrate and the color filter element is oriented towards the first substrate, in order to provide a color display on said display surface in a transmissive mode of the display device, in which light is emitted by the background illumination from the first transparent substrate through the relevant color filter elements to the second transparent substrate, and to provide a colorless display in a reflective mode, in which light coming in through the second substrate is reflected back to the second transparent substrate directly by the relevant reflection elements.

13. The display device according to claim 12, further comprising a first polarizer which is deposited on the first transparent substrate, and a second polarizer which is deposited on the second transparent substrate and has a polarization plane that is perpendicular to that of the first polarizer.

14. A display device according to claim 12, wherein the electro-optical material comprises a layer of liquid crystals.

15. A display device according to claim 12, wherein the first electrodes are arranged parallel to each other and extend in a first direction, while the second electrodes are likewise arranged parallel to each other and extend in a second direction which is perpendicular to the first direction.

16. A display device according to claim 12, wherein the first and second electrodes are made of a transparent material.

17. The display device according to claim 12, wherein the display device is an active matrix liquid crystal display, being one of a TFT liquid crystal display, a passive matrix liquid crystal display, and a CSTN liquid crystal display.

18. The display device according to claim 12, wherein the relevant color filter elements comprise the colors red, yellow and blue.

19. The display device according to claim 18, wherein one color pixel is represented in each case by three adjacent image dot sections having the colors red, yellow and blue.

20. The display device according to claim 12, wherein he display device is incorporated into an electrical apparatus.

21. The display device according to claim 12, wherein the display device is incorporated into a mobile apparatus.

22. The display device according to claim 12, wherein the display device is incorporated into a mobile telephone, a portable computer or clock.
